(19) United States
(12) Patent Application Publication
(10) Pub. No.: US 2006/0161486 A1
(43) Pub. Date: Jul. 20, 2006

(54) Financial services credit program

(75) Inventor: Randall Thomas Wasserman, San Diego, CA (US)

Correspondence Address: GORDON & REES LLP, 101 WEST BROADWAY, SUITE 1600, SAN DIEGO, CA, 92101, US

(73) Assignee: Infusit

(21) Appl. No.: 11/040,703

(22) Filed: Jan. 20, 2005

(51) Int. Cl. G06Q 40/00

(52) U.S. Cl. 705/35

(57) ABSTRACT

In the present invention, consumers are issued a credit card that is secured by the consumer's vehicle. This new card will combine all the best features and benefits of a traditional credit card, along with the higher loan amounts of a traditional consumer loan and the ease of origination, funding, and security of a car title loan. Additional benefits include open-ended terms instead of traditional fixed installment loan terms, lower monthly payments, higher credit limits, and flexible, revolving lines of credit. No other bank or lender currently issues a credit card secured by a customer's vehicle. While there are a number of banks that offer secured credit cards, none of them are secured with a cardholder's vehicle, and while there are a number of conventional consumer, auto, and car title lenders that make loans secured by a customer's vehicle, none of them issue credit cards.

### FIELD OF THE INVENTION

The present invention relates to the field of financial services. Specifically, this invention relates to the area of consumer loans, auto loans, and credit cards.

### BACKGROUND OF THE INVENTION

Many years ago banks, credit unions and savings and loan institutions stopped providing small consumer loans to individuals, thus creating a huge void in the small consumer loan marketplace. In the past, banks made small loans to consumers for a wide variety of personal reasons. However, as time went on, most banks and financial institutions were only interested in large returns on their investments and focused on bigger loans such as making real estate loans, home equity loans, new car loans and credit cards. As a result, individuals who want to borrow a small amount of money, such as $500 to $5,000, are quickly left with very few options, and what few options they have can be very unattractive. If they do not have good credit, a good income, low debt, and the time to wait up to a week or more to receive a conventional consumer loan or credit card, their only option is to go to one of the fringe lenders such as check cashiers, pawnbrokers, payday advance stores and car title lenders. However, these types of lenders are very expensive, and while they have filled part of the void, they only create one-time, short-term solutions that do not meet consumer's long-term financial needs. Even with the fairly recent addition of payday advance stores in the marketplace, there is still a large void and demand for money that currently is not being filled.

What is needed is a financial services institution to create an entirely new, consumer friendly financial product that will better provide consumer loans and credit to consumers nationwide in a fast, friendly, and professional manner.

### SUMMARY OF THE INVENTION

It is an object of the present invention to issue credit cards to consumers that are secured by the consumer's vehicle.

It is another object of the present invention to provide credit to consumers quickly in a friendly, efficient and professional manner.

It is yet another object of the present invention to offer credit loans that have many more features and benefits then traditional consumer, auto, or car title loans, such as higher credit limits and lower monthly payments.

In an exemplary embodiment of the present invention, three existing multi-billion dollar subprime market industry segments are combined seamlessly into one operation for the first time: the credit card industry, the conventional consumer lending industry, and the auto loan and car title lending industry. In this invention, consumers are issued credit, in the form of a credit card, a debit card or a smart card, that is secured by the consumers' vehicle. The credit is provided to the consumer in the form of a credit card that offers consumers an open-ended term as opposed to the traditional amortized installment loan term that is the standard for all consumer, auto, and car title loans. This provides consumers a flexible, revolving line of credit, which can be used whenever the consumer needs it. The line of credit is based primarily upon a percentage of the value of the consumer's vehicle, along with other factors taken into consideration such as their credit history and ability to pay.

The consumer is only charged interest on the money that is used, and unlike traditional auto and consumer loans, the monthly payments are based upon the outstanding principal balance, not the original amount of the loan. Additionally, with traditional auto and consumer loans, the loan terms are fixed for a specific amount of years and the consumer pays the same monthly payment month after month, even if the consumer has paid down the principal balance by more than half. Furthermore, with traditional installment-type auto and consumer loans, once the loan is made, it is extremely difficult for the lender to change any of the loan terms. With the present invention however, the credit limit and interest rate can be lowered or raised at anytime without redoing any paperwork or signing a new note. Thus, the lender can increase or decrease the consumer's interest rate should financial conditions or the consumer's payment history warrant it, which gives the lender the ability to reward the consumer or minimize the lender's risk accordingly. The benefits to the consumer are many, and include the ability to borrow more with a higher credit limit should the consumer need it, or be rewarded for a good payment history with lower interest rates.

In the exemplary embodiment of the present invention, approval and credit limit decisioning is primarily based upon the value of the consumer's vehicle and does not rely upon the financial strength or credit history of the consumer. This allows consumers who may not be able to obtain a traditional credit card or consumer loan to be able to obtain credit using the equity in their vehicle. The credit card issued with the line of credit offers features and benefits that traditional credit cards, consumer, auto, and car title loans do not. These benefits include higher credit limits, lower interest rates, an open-ended loan term and lower monthly payments. In addition, the credit card issued in the present invention can be utilized to obtain cash at most ATM's throughout the United States, as well as purchase goods and services from retailers throughout the world. In additional embodiments, features and benefits such as auto insurance, frequent flyer miles or discount purchase and cash back incentives can also be added to the credit card.

The foregoing, together with other features and advantages of the present invention, will become more apparent when referring to the specification, claims and accompanying drawings.

### BRIEF DESCRIPTION OF THE DRAWINGS

The present invention will be better understood from the following detailed description of an exemplary embodiment of the invention, taken in conjunction with the accompanying drawing in which:

FIG. 1 illustrates a flow diagram of a method of the preferred embodiment of the present invention.

### DETAILED DESCRIPTION

In an exemplary embodiment of the present invention, cards, such as credit cards, debit card and smart cards (hereinafter referred to as “credit cards”) are issued to consumers in lieu of traditional consumer, auto, and car title loans, and the loan is secured by a consumer's vehicle. Vehicles include but are not limited to cars, motorcycles, trucks, vans, boats and recreation vehicles. The credit limit of the card is based upon the value of the consumer's vehicle, not how much money the consumer can retain on deposit with a bank. With traditional secured credit cards, banks require the consumer to deposit money into a savings account at their bank as security for the credit card, and the credit limit is equal to, or less, than the amount deposited. Access to the account is frozen while the consumer has the card so that the funds in the account may be used to cover the consumer's credit card obligations.

Since cards issued based upon an exemplary embodiment of the present invention are secured by the consumer's vehicle, the credit limit will be much higher than a traditional secured credit card, which will make it a more attractive option for the consumer who does not have a lot of money or needs a higher credit limit. Additionally, the consumer will be offered an open-ended term, verses the traditional amortized installment loan. An open ended term is more attractive to consumers because their monthly payments will be considerably lower than traditional, installment type loans. This will make credit much easier to obtain for many consumers, because in traditional lending, more people are turned down for loans then are approved. For most of these consumers, they are turned down because they can not afford the high monthly payments, or they do not qualify due to a lack of time at their job, not enough income, too much debt, or a poor credit history. With this invention, these factors do not weigh as heavily, as approval and the credit limit will be based primarily upon the value of the consumer's car, not the strength of their credit or the amount of money they can deposit into a savings account. Thus, this new card will be much easier to obtain than conventional consumer loans, car title loans, or conventional secured credit cards, which means that millions of people who do not currently qualify for traditional loans or credit cards will qualify for this invention.

The exemplary embodiment of the present invention also provides consumers with a flexible, revolving line of credit, which can be used when needed. Consumers can borrow up to their credit limit, then pay down the amount owed and then re-borrow more money over and over again. The revolving line of credit can be in any amount which is much better than a fixed loan as it gives the consumer more options such as the option to borrow only as much money as is needed. Plus, if the consumer has a good payment history, the lender has the ability to lower the consumer's interest rates as a reward.

In addition to providing millions of people access to credit who would not normally have access to credit, the exemplary embodiment of the present invention provides additional benefits to lenders. These benefits include a larger market, higher approval rates, more fee income, and less liability. There will be more fee income because, with traditional consumer, auto and car title loans, the lender is typically only allowed to charge interest, a loan fee, and late fees. With this invention however, in addition to the above fees, a multitude of other fees may also be charged to the customer. These include fees such as annual membership fees, monthly usage fees, per transactions fees, over-limit fees, cash advance fees, etc., which will create a significant, and powerful new income stream for the lender; one that will be many times that which traditional consumer or car title lenders typically obtain from their customers. Additionally, there will be less liability for the lender because with traditional credit cards, the biggest problem is that the card issuer is exposed to significant liability due to credit card fraud and identity theft. With this invention however, identity theft and credit card fraud liability will be reduced to almost zero. This unheard of low level of liability will be achieved because this new card is secured by the consumer's vehicle, and since the consumer must transfer title to their vehicle, which requires them to produce the actual car title, as well as proof of insurance and a Drivers License or other valid form of identification, credit card fraud and identity theft will be virtually eliminated.

If the consumer already has a loan on the vehicle, the lender will determine how much equity the consumer has in the vehicle. If the existing loan is for a rather large percentage of the value of the vehicle, such as 80% or greater, then the consumer will most likely be turned down. However, if the consumer has a larger percentage of equity and owes a smaller percentage of the value of the vehicle, when the consumer is offered credit, a portion of the credit line will be used to pay off the existing loan so that the new lender can become the sole lien holder on the vehicle. For example, if it is determined the consumer is approved for credit in an amount that is equal to 50% of the value of the vehicle and the consumer still owes 25% of the value of the vehicle to a lien holder, the new lender will pay off the existing loan (or lien), leaving the consumer the remaining available balance of credit to use at their discretion. In this example, the consumer is issued credit equal to 50% of the value of the vehicle, and, after satisfying the original lien, will have a principal balance due to the new lender of approximately 25%, and an available credit balance of approximately 25%. As the consumer pays down the outstanding principal balance, the amount of credit available to the consumer increases. This type of financial transaction, which is a form of refinancing, can not typically be done to benefit the consumer with traditional, existing loan or credit products, but can be done with this invention with great results. For example, it is common for an existing installment-type auto or consumer loan to be refinanced with another auto or consumer loan with better rates and terms; and it is common for outstanding credit balances (such as those from credit cards) to be consolidated and refinanced to a fixed, installment-type loan for the benefit of the consumer, but it has never been in the best interest of the consumer to refinance a fixed, installment-type of auto or consumer loan with a credit card—until now. With this invention, fixed, installment-type auto and consumer loans can now be refinanced to a credit card for the benefit of the consumer. These benefits include cash back, significantly higher credit limits, lower monthly payments, and an open-ended loan term with an available revolving line of credit that can be used whenever it is needed.

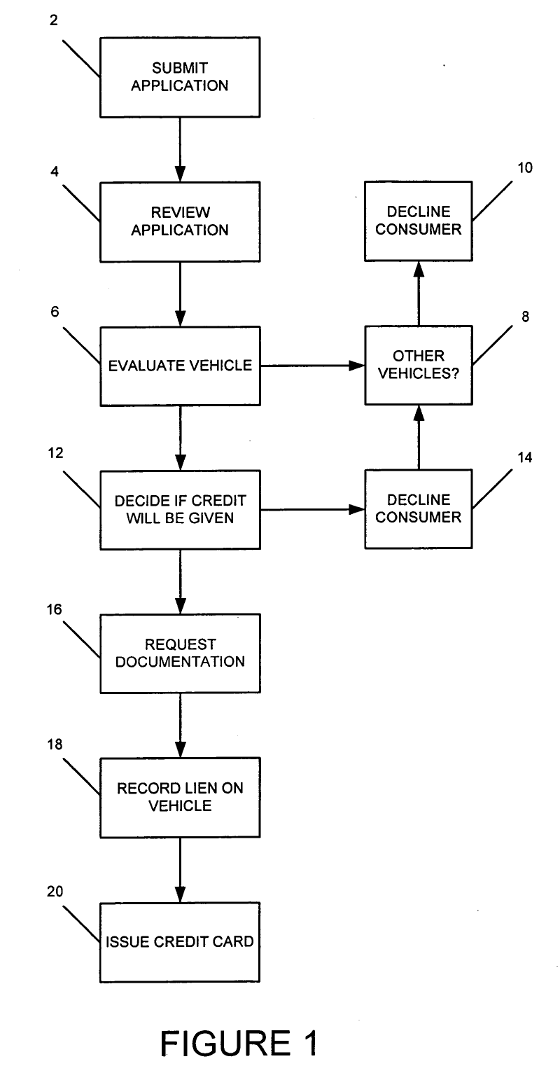

FIG. 1 illustrates the steps of the method of an exemplary embodiment of the present invention. To obtain a credit card, a consumer completes an application, either electronically or on-line 2. Typical questions the consumer will be required to answer include, but are not limited, to the following:

1. Do you own a vehicle?

2. If so, is the vehicle paid off?

3. What is the make, model and year of your vehicle?

4. What is the condition of the vehicle?

5. Do you have insurance on your vehicle?

6. Are you currently employed and/or have a stable source of income?

Once the consumer submits the application, the application is reviewed 4 and a decision is made either manually or electronically as to whether the consumer will be provided with a credit card secured by the consumer's vehicle. If the application is reviewed manually, a loan officer from the lending company will be notified that a new application has been received and is awaiting review. When the application is submitted, the application is entered into a database. The loan officer will then log into the database containing the application, open the application and review it for completeness. If additional information is needed from the consumer, the loan officer may contact the consumer to obtain this information.

To make a determination, the loan officer will first evaluate the consumer's vehicle 6 listed on the application to determine if it meets the minimum requirements for use as security, such as if the vehicle is paid off and if not, how much is owed on the vehicle. If the minimum requirements are met, the vehicle is then valued by the loan officer using industry standard valuation guides such as those published by Kelley Blue Book or the National Auto Dealers Association. If the vehicle does not qualify, the consumer is contacted and asked if they have any other vehicles that can be used as security 8. If not, the consumer is informed that credit will not be able to be given at this time 10. If the vehicle does qualify, the loan officer will obtain the consumer's credit report from one of the three major credit bureaus. The report will be reviewed and analyzed by the loan officer to determine if the consumer meets the minimum qualifications for approval 12. If the consumer does not meet the minimum requirements, the request for credit is declined 14 and the consumer is informed.

In reviewing the application, the loan officer assesses all key factors to determine if the consumer can be approved. Factors such as the value of the consumer's vehicle, the consumer's income, the consumer's debt to income ratio, the length of time of the consumer's residency and employment, the consumer's credit history and overall financial stability are some of the factors that may be taken into consideration. If the consumer meets all the established qualifications by the lender, the loan officer gives the consumer pre-approval status. If the consumer does not meet all the qualifications or if the loan officer feels that the applicant cannot afford additional debt, the consumer's request for credit is declined.

Next, the loan officer will determine a credit limit based upon several factors including the loan-to-value ratio of the vehicle used as security and the consumer's ability to pay. Then, using the information collected from the application, the vehicle evaluation and the credit report, the loan officer will determine the interest rate the application qualifies for. This may be a fixed rate, a variable rate or a tiered rate structure. The interest rate is based upon current financial and economic conditions. Next, the loan officer will print a quote containing all federal truth in lending standards and the consumer is contacted and informed of the pre-approval status. The loan officer will then go over the rates and terms with the consumer in detail.

The above-described steps can also be done electronically at the time the consumer submits the application on-line. Once the consumer submits the application, the information or data supplied by the consumer is analyzed by a program which runs it through a series of filters that compares the consumer's information to the qualifications or requirements established to determine if the consumer is entitled to receive credit. If the minimum requirements are met, the consumer is immediately informed of the pre-approval status and the rates and terms of the credit to be issued. If any information in the application does not meet the minimum requirements, the consumer's request for credit is turned down.

Once the credit limit, rates and terms have been determined, the loan officer (or software program if done electronically) informs the consumer what documentation will need to be received prior to issuing a card 16. The required documentation will include the vehicle title (or a valid registration showing the lender as lien holder in lieu of a title), and may include other additional items such as proof of employment and/or income, proof of residency, proof of insurance and a copy of the consumer's driver's license. Once the required documents have been received from the consumer, they are reviewed for completeness and authenticity, and then compared to the customer's credit application for accuracy. The consumer is contacted if any items are incomplete, inaccurate or need clarification. A final review of all items is conducted and if all requirements have been received and everything is in order, final approval is given.

After approval, the loan officer will review the consumer's Department of Motor Vehicle (DMV) lien holder requirements for the state in which the consumer resides. For example, a lien may be recorded electronically in some states, while other states require the registered owner's notarized signature on the title before a lien can be filed. As every state's lien filing requirements are different, the loan officer must review the individual state's requirements to determine what steps must be taken and if the consumer needs to be involved.

Next, the credit card and security agreements are prepared and printed. The customer is contacted and the loan officer reviews the agreement terms and signing instructions with the consumer, as well as any state related DMV requirements if necessary. If the consumer is not present with the loan officer, a complete document package is prepared for delivery to the customer, which may include, but is not limited to, the following items:

1. The credit card agreement

2. The security agreement

3. Agreement signing instructions

4. Title signing instructions (state specific)

5. Notary instructions (state specific)

6. DMV form(s) (state specific)

7. Insurance authorization form

8. The lender's privacy policy

9. Credit card disclosure

10. Credit card cash advance & balance transfer authorization form

11. Prepaid return addressed overnight envelope

The document package is printed and then delivered to the customer in one of many ways including, but not limited to, the United States Postal Service, an overnight delivery service, the customer can personally pick up the package from the lender or one of its affiliates or the package can be hand delivered.

Upon receipt of the documents, the consumer fills in all the required information on the documents and returns the executed documents to the loan officer. The loan officer then verifies that all documents have been properly completed, signed and notarized per instructions in the package. Next, the consumer's information is entered into the lender's database and credit servicing system.

Then, the insurance authorization is faxed to the consumer's auto insurance company to add the lender as a lien holder and loss payee. Next, the proper DMV form is filled out which adds the lender as a lien holder on the consumer's vehicle and is filed with the appropriate DMV office so that the lien can be officially recorded 18. Finally a credit card will be issued to the consumer 20.

If the customer has requested a cash advance or a balance transfer, this transaction can be completed in one of the following ways:

Hand the consumer a check for the amount requested amount
1. Mail a check to the consumer
2. Deposit the money directly into the consumer's bank account
3. Transfer the money by means of Automated Clearing House (ACH)
4. Wire the money directly to the consumer
5. Transfer the money to another credit account designated by the consumer

Although an exemplary embodiment of the invention has been described above by way of example only, it will be understood by those skilled in the field that modifications may be made to the disclosed embodiment without departing from the scope of the invention, which is defined by the appended claims.

I claim:

1. A method of providing a consumer with credit based upon a vehicle owned by the consumer, the method comprising the steps of:
evaluating the consumer's vehicle to determine if the vehicle meets minimum requirements for use as security;
determining if the consumer meets minimum qualifications for approval based upon information provided by the consumer in an application;
determining a credit limit, interest rate and terms for a loan to be provided to the consumer if the vehicle meets the minimum requirement and if the consumer meets the minimum requirements;
requesting documentation from the consumer to verify the information the consumer has provided;
filing and recording a lien on the consumer's vehicle; and
providing the consumer with a card which contains a line of credit based upon a percentage of the value of the vehicle.

2. The method of claim 1, wherein the vehicle is selected from a group consisting cars, motorcycles, trucks, vans, boats and recreation vehicles.

3. The method of claim 1, wherein the interest rate is selected from the group consisting of a fixed rate, a variable rate and a tiered rate structure.

4. The method of claim 1, wherein the card is selected from the group consisting of credit card, debit card and smart card.

5. The method of claim 1, further comprising the steps of:
adding a lien to the consumer's vehicle by filing the lien with the appropriate office or department of motor vehicles for the state in which the vehicle is registered in and;
informing the consumer's insurance company that credit has been issued to the consumer based upon the consumer's vehicle.

6. The method of claim 1, wherein requirements utilized to determine if the consumer's vehicle is available for use as security are selected from the group consisting of whether the vehicle is paid off, the make model and year of the vehicle, the condition of the vehicle and if the consumer has insurance on the vehicle.

7. The method of claim 1, wherein qualifications utilized to determine if the consumer is to qualify for the line of credit are selected from the group consisting of the consumer's income, the consumer's debt to income ratio, the length of time of the consumer's residency and employment, the consumer's credit history and overall financial stability.

8. The method of claim 1, wherein the consumer can receive a cash advance based on a percentage of the value of the consumer's vehicle.

9. The method of claim 8, wherein consumer can receive the cash in the form of a check based upon a percentage of the value of the vehicle.

10. The method of claim 8, wherein the cash can deposited directly into the consumer's bank account.

11. The method of claim 7, wherein the cash can be transferred to another credit account designated by the consumer.

12. The method of claim 1, wherein the credit card can be used to obtain cash at ATM's.

13. The method of claim 1, wherein the credit card can be used to purchase goods and services from retailers throughout the world.

14. The method of claim 1, wherein additional features such as auto insurance, frequent flyer miles or discount purchase and cash back incentives can also be added to the credit card.

15. The method of claim 1, wherein the credit limit and interest rate can be lowered or raised at anytime.

16. The method of claim 1, wherein monthly payments are flexible, based upon the outstanding principal balance, and not fixed monthly payments based upon the amount of the loan.

17. A method of reducing the lender's liability, the method comprising the steps of:
issuing a consumer credit based on the percentage of the value of a consumer's vehicle; and
securing the ability to repossess the by:
adding a lien to the consumer's vehicle by filing the lien with the appropriate office or department of motor vehicles for the state in which the vehicle is registered and/or titled in and;
informing the consumer's insurance company that credit has been issued to the consumer secured by the consumer's vehicle.

18. The method of claim 17, wherein credit card fraud and identify theft are virtually eliminated as the consumer is required to produce the actual title to the vehicle, proof of insurance and a drivers license.
